(19) United States
(12) Patent Application Publication
(10) Pub. No.: US 2008/0114964 A1
(43) Pub. Date: May 15, 2008

(54) Apparatus and Method for Cache Maintenance

(76) Inventors: Gordon T. Davis, Chapel Hill, NC (US); Richard W. Doing, Raleigh, NC (US); John D. Jabusch, Cary, NC (US); M V V Anil Krishna, Cary, NC (US); Brett Olsson, Cry, NC (US); Eric F. Robinson, Raleigh, NC (US); Sumedh W. Sathaye, Cary, NC (US); Jeffrey R. Summers, Raleigh, NC (US)

Correspondence Address: IBM CORPORATION, PO BOX 12195, DEPT YXSA, BLDG 002, RESEARCH TRIANGLE PARK, NC, 27709, US

(21) Appl. No.: 11/559,512

(22) Filed: Nov. 14, 2006

(51) Int. Cl. G06F 9/305

(52) U.S. Cl. 712/2; 712/E09.018

(57) ABSTRACT

A single unified level one instruction cache in which some lines may contain traces and other lines in the same congruence class may contain blocks of instructions consistent with conventional cache lines. Control is exercised over which lines are contained within the cache. This invention avoids inefficiencies in the cache by removing trace lines experiencing early exits from the cache, or trace lines that are short, by maintaining a few bits of information about the accuracy of the control flow in a trace cache line and using that information in addition to the LRU (Least Recently Used) bits that maintain the recency information of a cache line, in order to make a replacement decision.

### FIELD AND BACKGROUND OF INVENTION

Traditional processor designs make use of various cache structures to store local copies of instructions and data in order to avoid lengthy access times of typical DRAM memory. FIG. 1 illustrates a typical cache hierarchy, where caches closer to the processor (L1) tend to be smaller and very fast, while caches closer to the DRAM (L2 or L3) tend to be significantly larger but also slower (longer access time). The larger caches tend to handle both instructions and data, while quite often a processor system will include separate data cache and instruction cache at the L1 level (i.e. closest to the processor core). All of these caches typically have similar organization as illustrated in FIG. 2, with the main difference being in specific dimensions (e.g. cache line size, number of ways per congruence class, number of congruence classes). In the case of an L1 Instruction cache, the cache is accessed either when code execution reaches the end of the previously fetched cache line or when a taken (or at least predicted taken) branch is encountered within the previously fetched cache line. In either case, a next instruction address is presented to the cache. In typical operation, a congruence class is selected via an abbreviated address (ignoring high-order bits), and a specific way within the congruence class is selected by matching the address to the contents of an address field within the tag of each way within the congruence class. Addresses used for indexing and for matching tags can use either effective or real addresses depending on system issues beyond the scope of this disclosure. Typically, low order address bits (e.g. selecting specific byte or word within a cache line) are ignored for both indexing into the tag array and for comparing tag contents. This is because for conventional caches, all such bytes/words will be stored in the same cache line.

Recently, Instruction Caches that store traces of instruction execution have been used, most notably with the Intel Pentium 4. These “Trace Caches” typically combine blocks of instructions from different address regions (i.e. that would have required multiple conventional cache lines). The objective of a trace cache is to handle branching more efficiently, at least when the branching is well predicted. The instruction at a branch target address is simply the next instruction in the trace line, allowing the processor to execute code with high branch density just as efficiently as it executes long blocks of code without branches. This type of trace cache works very well as long as branches within each trace continue to execute as predicted. However, as a program proceeds from one phase to the next, frequently the execution patterns change resulting in branch execution that is contrary to the instruction sequences stored in traces. Some traces may no longer be executed at all, and will eventually be replaced via standard LRU replacement algorithms within the cache. Other trace lines may experience continued execution, but with a mispredicted branch in the middle of the trace causing an early exit of the trace. Since significant portions of such trace lines are not executed, the efficiency of the cache is reduced. Moreover, since the early exit from such traces is not anticipated, branch misprediction penalties are incurred due to the delay in fetching the appropriate instructions at the target of the branch. What is needed is an effective mechanism to remove such traces from the cache to allow alternate trace lines (starting at the same instruction) that more completely follow the current instruction execution pattern.

One limitation of trace caches is that branch prediction must be reasonably accurate before constructing traces to be stored in a trace cache. For most code execution, this simply means delaying construction of traces until branch history has been recorded long enough to insure accurate prediction. However, some code paths contain branches that change execution patterns as a program progresses. This can result in an early exit from a trace line when, for example a branch positioned early in a trace was predicted not taken when the trace was constructed, but is now consistently taken. Any instructions beyond this branch are never executed, essentially becoming unused overhead that reduces the effective utilization of the cache. Since the branch causing the early exit is unanticipated, significant latency is encountered (branch misprediction penalty) to fetch instructions at the branch target.

Least Recently Used (LRU) and Pseudo-LRU have shown to perform very well in making such replacement decisions in conventional cache designs, where a cache line is a contiguous sequence of instructions in memory storage order. With Instruction Caches that hold execution traces instead of sequential instructions as held in memory, using recency alone to qualify the usefulness of a cache line may not result in the most effective use of cache storage. Recency alone is enough to quantify the usefulness of a cache line in conventional cache designs because if an instruction is requested by the processor, there is a unique cache line that can hold it. When the cache line is brought in, there is no possibility that there might be a different cache line holding the same instruction that might be more useful than this cache line. Therefore the cache line most recently brought in is also the most useful in terms of temporal and spatial locality. When a sequence of instructions stored in a cache line mimic the execution pattern that those instructions are expected to follow, there can be multiple cache lines holding the same instruction. An instruction may be “reached” during execution through different paths, depending on the control flow in the program. This creates the possibility that a cache line holding the instruction requested by the processor, might be available in the cache, and yet, that cache line might not represent the true execution sequence leading up to or following that instruction in the current phase the program is executing in. Traditional LRU or pseudo-LRU mechanisms may mark such an erroneous “trace” or execution sequence maintained in the cache as the most-recently-used status upon reference. The trace cache line stays in the cache longer and may lead to wasted space in the cache, since it holds possibly non-relevant paths through execution. Performance of the processor also suffers because in trace cache designs where execution follows a trace line and predictions built in to it, with corrective action for a wrongly predicted control flow starting only after the full branch penalty is incurred. Also, no preference is given to traces which might utilize the available space in a cache line better simply by being longer than an equally accurate shorter trace line which had to be curtailed in length during trace construction due to special trace formation rules. An example of such a rule might be stopping trace formation upon reaching a call or return instruction. Usually this is done since there is a multitude of possible targets for such an instruction.

### SUMMARY OF THE INVENTION

A purpose of this invention is to avoid such inefficiencies by removing trace lines experiencing early exits from the cache, thus allowing standard mechanisms to build new trace lines that better match current execution patterns. This is accomplished via a modification to the mechanism that updates the LRU (Least-Recently-Used) state of the cache line. LRU state is updated only for trace lines that execute as predicted, causing traces experiencing early exits to migrate toward the LRU position and eventually be replaced. An additional object of this invention is to optionally also update LRU state for a trace line experiencing an early exit close to the end of the trace, since the bulk of the trace is still useful.

Another purpose is to avoid inefficiencies in the cache by removing trace lines experiencing early exits from the cache, or trace lines that are short, thus allowing standard mechanisms to build new trace lines that better match current execution patterns. This is accomplished by maintaining a few bits of information about the accuracy of the control flow in a trace cache line and using that information in addition to the LRU(Least Recently Used) bits that maintain the recency information of a cache line, in order to make a replacement decision. The LRU state is updated as in a traditional cache, upon accessing a cache line. The control-flow-accuracy information for the cache line, however, is updated as execution proceeds through the path predicted by the trace cache line. In the preferred embodiment of this replacement policy, LRU bits are used to find a plurality of “less” recently used cache lines. The control-flow-accuracy and space-efficiency of each of these trace cache lines (also referred to as trace lines) is calculated using the extra bits maintained per trace line. Using a certain weighting function that in general gives lesser weight (and therefore lesser preference) to more recently used lines, the control-flow-accuracy and space-efficiency for the candidates are used to calculate their overall usefulness. The candidate cache line deemed least useful is evicted.

### BRIEF DESCRIPTION OF DRAWINGS

Some of the purposes of the invention having been stated, others will appear as the description proceeds, when taken in connection with the accompanying drawings, in which:

FIG. 1 is a schematic representation of the operative coupling of a computer system central processor and layered memory which has level 1, level 2 and level 3 caches and DRAM;

FIG. 2 is a schematic representation of the organization of a L1 cache instruction cache;

FIG. 3 is a schematic representation of the data organization in tag and data arrays of the cache in accordance with this invention;

FIG. 4 is a representation of the bits in a tag array entry in one example implementation of this invention;

FIG. 5 is a schematic representation of the feedback path for updating a trace line; and

FIGS. 6A and 6B, together constituting FIG. 6, show an example for the evaluation of a replacement trace line.

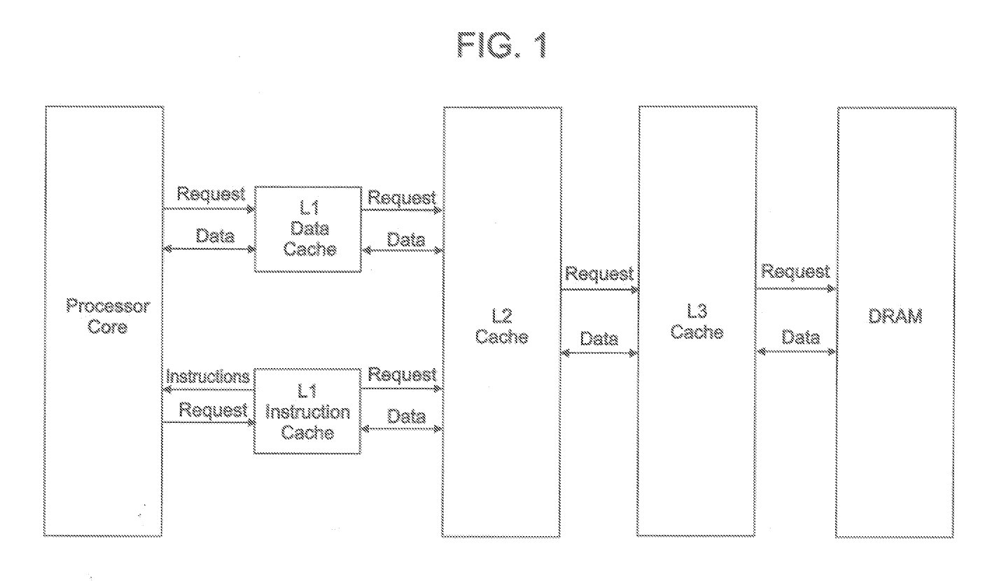

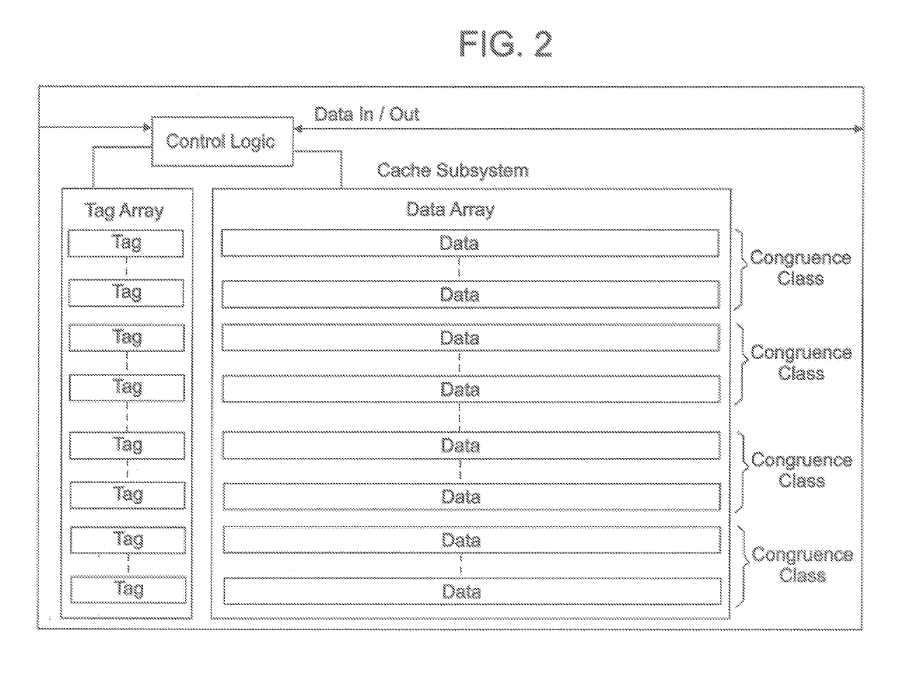

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

The term “programmed method”, as used herein, is defined to mean one or more process steps that are presently performed; or, alternatively, one or more process steps that are enabled to be performed at a future point in time. The term programmed method contemplates three alternative forms. First, a programmed method comprises presently performed process steps. Second, a programmed method comprises a computer-readable medium embodying computer instructions which, when executed by a computer system, perform one or more process steps. Third, a programmed method comprises a computer system that has been programmed by software, hardware, firmware, or any combination thereof to perform one or more process steps. It is to be understood that the term programmed method is not to be construed as simultaneously having more than one alternative form, but rather is to be construed in the truest sense of an alternative form wherein, at any given point in time, only one of the plurality of alternative forms is present.

A conventional cache (instruction, trace, or data) typically marks a line as MRU (Most-Recently-Used) when it is read from the cache. A line that is not referenced migrates toward LRU as other lines in the same congruence class are referenced and marked as MRU. When a new line is added to that congruence class, it replaces the line classified as LRU. The improved mechanism of this invention delays update of the LRU state until execution of a trace line is complete.

If the trace line executes to completion as originally predicted, the state of the cache line is marked MRU. This behavior is similar to normal cache behavior, except that the action of updating the state is delayed until after execution instead of being altered when read. On the other hand, if execution of the trace line results in an early exit, the LRU state of that line is not updated. If repeated execution of this trace line continue to branch out of the trace before the end, the state of the trace line in cache should eventually migrate to LRU as a result of other cache lines being referenced (and marked MRU) or replaced by new lines. Once the line reaches the LRU state, the next new line required in the same congruence class will cause it to be cast out of the cache.

There are two scenarios for an early exit while executing a trace line:

Trace is constructed with a branch predicted flow-through (i.e. The instruction after the branch in the trace is the next sequential instruction in the original code image.), but the branch is actually taken. Trace is constructed with a branch predicted taken (i.e. The instruction after the branch in the trace is the instruction located at the target address of the branch in the original code image.), but the branch actually flows through to the next sequential instruction in the original code image. Note that even though the next sequential instruction is needed, it may not be immediately accessible from a trace cache.

In a preferred embodiment, any early exit would inhibit update of the LRU state of the trace line. An alternate embodiment might allow LRU state to be updated even when encountering an early exit, as long as the early exit occurs near the end of the trace line (e.g. the bulk of the trace line has been used). In either case, a mispredicted branch at the very last instruction of a trace line would not prevent LRU state update, although it might update the branch target field in the trace line. In a preferred embodiment, each trace line in the cache would include a field to identify the number of instructions in that cache line. As instructions from the cache line are executed, they are counted. When a request is encountered for the next block of instructions beyond the current trace line, the executed instruction count is compared to the trace length identified in the cache line. If the executed instruction count is less than the trace length, an early exit is declared, and updating of the LRU state of the trace line is inhibited. On the other hand, if the count is equal to the length, the LRU state for the trace line is updated to MRU.

In the above discussion, it was assumed that all traces are initially constructed with well predicted branches, and those traces continue for a while at least to execute those branches as predicted, but then switch to a different phase of the program where a particular branch always goes opposite to the direction predicted. There are also frequently branches that are inherently unpredictable (i.e. data dependent or toggle). In these cases, it may be beneficial to keep the full trace in the cache since the entire trace is still executed at least some of the time. As long as full trace execution occurs often enough, the mechanisms of the subject invention will mark the line MRU often enough to prevent it from being removed from the cache as LRU, even though it may not mark the line as MRU every time it is referenced.

Note that the subject invention may be employed in a cache that contains both conventional cache lines and trace cache lines, as described in a co-pending application entitled “Apparatus and Method for Supporting Simultaneous Storage of Trace and Standard Cache Lines” and filed Oct. 4, 2006 under Ser. No. 11/538,445. In such a system, LRU update is delayed and sometimes inhibited only for trace lines. Access to a conventional cache line will immediately and unconditionally cause the LRU state of that line to be updated to MRU.

The specific sequence of actions required for operation of the subject invention include the following:

Read new cache line from instruction cache.

If cache line is a conventional cache line, update LRU state to MRU, and end process.

If cache line is a trace line, temporarily prevent update of LRU state, and set cache line state to active.

Wait for next cache line access request.

Once next cache line is accessed, determine if the active cache line was executed to completion.

If active cache line executed to completion, update LRU state to MRU Set cache line state to not active.

Repeat above steps for each subsequent cache line.

The chief advantage of the replacement policy described in this disclosure, over traditional approaches that work for conventional Instruction Caches, is that it provides a more efficient cache utilization for Instruction Caches storing temporally and spatially local execution traces. This leads to better processor run-time and therefore performance. Traces which are longer and/or more in tune with current execution patterns are retained, where as, traces that are either poor in utilization of the cache storage due to their short length or traces that maintain relatively stale control flow predictions, are given a greater chance to be evicted, in spite of their recency of use.

Using recency-of-use of a cache line, alone, when making replacement decisions, might not be able to maintain the best trace in a cache that holds traces. The usefulness of a trace depends on the accuracy of the control flow in the trace compared to the real control flow during current execution. The accuracy of control flow intends to reflect the relevance of the control flow information in the trace line. The trace line is assumed to have been constructed based on accurate control flow information generated by the branch prediction mechanisms and real execution. The built-in predictions for all or most of the branches in the trace line must continue to be accurate over time to validate the trace line's control flow as relevant to the then-current program execution.

Another aspect of a trace line that must be considered in evaluating its usefulness is how efficiently it uses the cache storage. As an example, if a trace line has very accurate control flow information for the first branch, but wrong control flow information for many other branches that follow in the same trace line, such that only a small percentage of the storage space (trace line size in bytes) actually stores useful instructions, it might be better to evict the line in the hope that a longer trace can be constructed, that still retains the control flow accuracy. As an opposite example, consider a trace with the first branch wrongly predicted in the trace, but all following branches very accurately predicted. In this case the situation is even worse since the instructions past the first branch can not be reached using the trace cache's tag-array search mechanisms. This renders this trace line quite inefficient in spite of possibly accurate predictions for latter branches. Another way to interpret this idea is that the overall usefulness of a trace line is affected more by the control flow accuracy for branches that are closer to the beginning of a trace line than the end. Another scenario where a trace line might be less efficient and therefore less useful is when it is short by construction. This can happen when an instruction that ends a trace is encountered early during trace formation. An example of such an instruction is a control flow instruction with multiple targets (like a call or return). Typically trace formation rules require a trace to be larger than a minimum size (e.g. more than m basic blocks or n instructions long).

In this invention a new cache line replacement policy is presented that provides for combining the accuracy of the control flow information maintained in a trace line and the effective space utilization by the trace line, with the usual recency-of-use information, when making decisions about its usefulness and therefore about replacement. Also disclosed are several methods to measure the accuracy of the control flow predictions provided by a trace cache line. Also disclosed are several methods to measure the effective utilization of space by a trace cache line.

In the description that follows, a “basic-block” refers to a group of sequential instructions ending in a control flow instruction such as a conditional branch. A control flow instruction refers to an instruction which may be followed by a non-sequential instruction during real execution. Typically branches occur every 4 or 5 sequential instructions in execution. A trace line typically consists of more than one basic-block—since trace caches can provide multiple basic blocks in a single access, resulting in fewer cache array accesses, and correspondingly lower power, while executing a given sequence of instructions. (A conventional cache will typically require a separate array access for each basic block.)

Trace formation or construction is a topic beyond the scope of this disclosure, and it suffices to say that it is done outside of the critical instruction fetch path. Trace construction can either go independent of the execution using the branch direction prediction and branch target evaluation mechanisms, or go in lock step with execution. Either way, typically traces that make it to the trace cache as trace lines have strongly predicted (be it taken or not-taken) branches. This is more true for implementations which do not use the branch predictions during fetch, if a trace line hit is found. Instead, the execution from a trace line relies on the lasting effects of the strong bias that the branches in the trace line had during trace formation. As execution continues and a trace line is searched for in the cache and is found, the sequence of basic blocks it holds is dispatched to the back end of the processor. Temporal locality implies there is a good chance that the trace will be used after construction, and path locality due to strong branches implies that the built-in predictions in the trace line will be quite accurate over time.

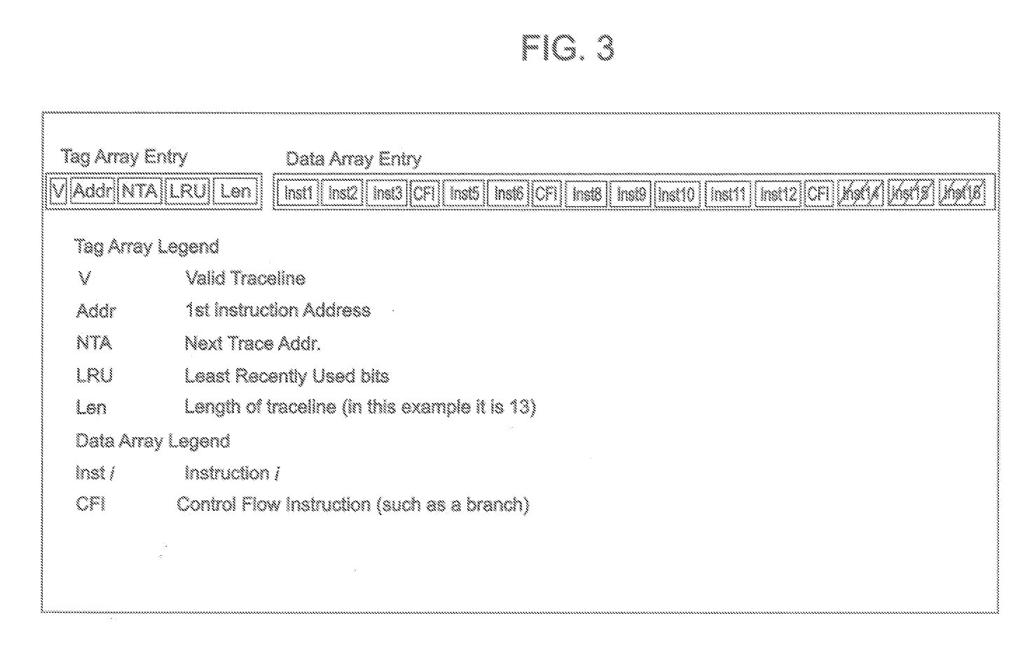

FIG. 3 shows an example trace line and the plurality of state bits maintained per trace line. These bits include a valid bit to indicate a valid entry in the data array, address of the first instruction (this is used during a tag search and typically holds the entire instruction address, and not just the higher order tag bits as in a conventional cache line), address of the next instruction to be fetched after the last instruction in this trace, the LRU state bits and the number of valid instructions in the trace line (a trace line unlike a conventional cache line, need not have valid instructions till the end of the cache line).

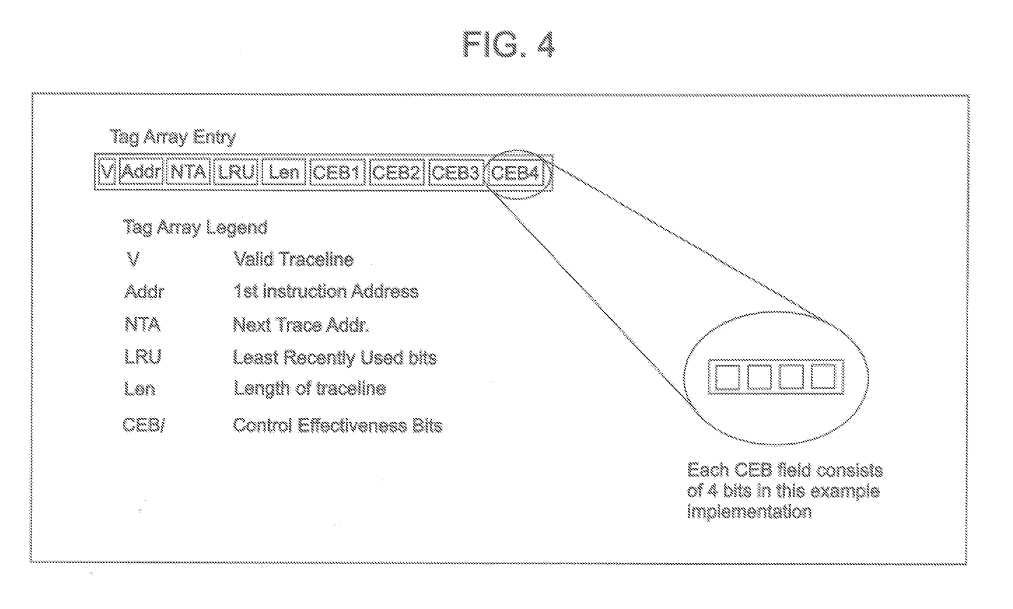

This invention contemplates an extension to the “Tag Array Entry” of FIG. 3, such that it allows recording of the effectiveness of the built-in control flow prediction in the trace line. As execution proceeds from the instructions in the trace line, these bits are updated after the execution of every control-flow instruction. A preferred implementation of these “Control Effectiveness Bits” (here onwards alternatively referred to as the CEB field) is shown in FIG. 4. A plurality of bits, say N bits, (shown to be 16 in FIG. 4) are maintained per trace line in the tag array. These bits are divided into M groups of N/M bits (assuming N is a multiple of M) each group corresponding to a control-flow instruction that ends a basic-block in the trace line. Therefore M is the maximum number of basic-blocks allowed in a trace line during trace formation. In FIG. 4 this is assumed to be 4, and therefore the number of bits maintained per control-flow instruction are 16/4=4. This allows each control-flow instruction to be associated with 2N/M states that may be used to maintain the relevance of the built in prediction. In the example shown in FIG. 4, there are 16 states associated with each control-flow instruction.

Several schemes for initializing and updating these bits and for using these bits in addition to the LRU bits for making replacement choices are discussed hereinafter. The specific implementation choice depends on the design constraints, such as power, area, logic complexity, workload characteristics etc. In one embodiment, the CEB field bits start at a value closer to the middle of the range from 0 to (2^{N/M}−1), say 0.5*(2^{N/M}). If there are fewer than M basic-blocks in the trace line, the bits corresponding to the non-existent branches start and stay at 0. When execution of a control-flow instruction in the back-end of the processor determines that the built-in prediction for that instruction in the trace was correct, the CEB field for that instruction is incremented by 1. When the execution determines that the prediction was incorrect, the CEB field is decremented by 1. The CEB field saturates count at (2^{N/M}−1) on the higher end and at 0 on the lower end.

In a different embodiment, the CEB field bits start at a value of 0. When execution of a control-flow instruction in the back-end of the processor determines that the built-in prediction for that instruction in the trace was correct, the CEB field for that instruction is incremented by 1. When the execution determines that the prediction was incorrect, the CEB field is left as is. The CEB field saturates count at (2^{N/M}−1) on the higher end. Therefore there is no explicit penalty for misprediction, except that eventually a trace line with mispredictions will be selected for replacement over another trace line that has fewer mispredictions.

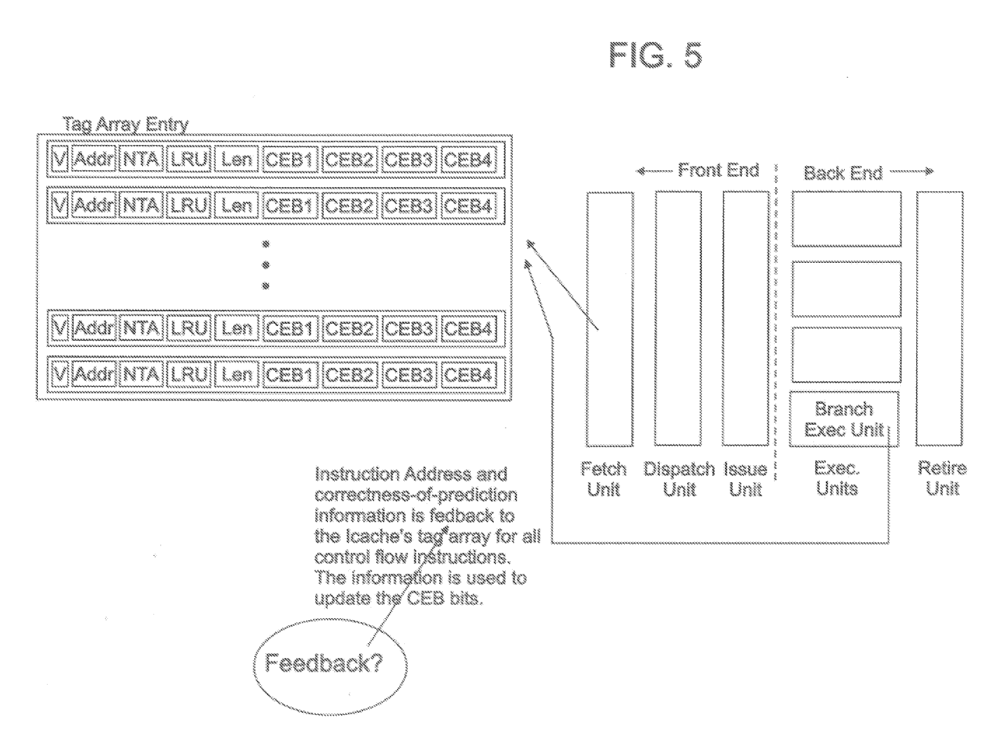

Other similar schemes might be implemented, with minor variations, as long as the basic notion of providing feedback to the trace line after execution of each, or all, the control-flow instructions is present. The feedback path required to update the trace line with the Control Effectiveness information is shown in FIG. 5. The effect of the overhead due to having such a feedback path can be minimized in many ways. Firstly, the Instruction Fetch unit might already have such a path to send back information to the Tag Array. A different solution might be to remember the index of the trace line and the location of the branch whose direction has been evaluated and requires being fed back to the tag array. The Tag Array could be index-addressable in addition to being content-addressable and the information remembered about the tag location could be used to update it without a tag search. Another solution might be to store the trace line for which the branch direction information is yet to be received, in a separate array temporarily and reinsert it into the Tag Array after the CEB bits are updated.

The feedback of the actual branch outcome to the tag array may be done in a “lazy” fashion, where the CEB bits are updated if the necessary bandwidth to the tag array is available. If it is not available, the update may be attempted at a later time, or dropped altogether.

With the CEB field holding the information about the effectiveness of the branches in a given trace line, there are several approaches to deciding how to find the least useful trace line.

A “control effectiveness factor” (here onwards alternatively referred to as CEF) is determined for these candidate trace lines. This CEF is determined by adding up the various CEB fields in a trace line with decrementing normalized weights associated with each branch. An example of the weights chosen for a trace line with M=4 (maximum of 4 basic-blocks per trace line) could be w1=0.50, w2=0.30, w3=0.15, w4=0.5. The weights corresponding to branches deeper in the trace line are smaller since their correct prediction has a lesser impact on the overall usefulness of the trace line. The bulk of the trace line has been correctly predicted in that case, and hence makes the trace line more “useful”, all other factors remaining equal (such as recency of use). In another embodiment of designing these weighing factors, the relative position of the branch instruction in the trace may be used to come up with the weights. That is to say, if a branch appears as the 5th instruction in the trace line, and another appears as the 15th, the former might be given a weight higher than the latter by some proportion that reflects their positions in the line.

CEF=w1*CEB1+w2*CEB2+w3*CEB3+w4*CEB4 (where CEB1, CEB2, CEB3 and CEB4 are as shown in FIG. 4)

CEBs take into account the relevance of the predictions in the trace line and the weights take into account the effective length (space-efficiency) of the trace line. If an early branch (control-flow instruction) in the trace is predicted wrong the penalty is higher for the trace line, than if a later branch in the trace line has a wrong prediction.

For traces with lesser than M basic-blocks and therefore CEB fields with 0 (or some such indicator of low counts), the score will automatically be lower than a trace that packs more basic blocks. This basically is an indicator that if a sequence of instructions has no branches it should not be using up valuable trace cache resources. Instead it should be using conventional cache lines in a cache that can hold both trace lines and conventional cache lines. In designs that do not have such an option, and implement only a trace cache with no supporting conventional cache, this problem of long useful traces with fewer branches being replaced often, can be overcome simply by setting the CEB fields for the non-existent branches to a somewhat higher number than 0, say (2^{N/M}−1). For trace lines that have fewer basic-blocks and are inherently shorter because of hitting a trace-formation end condition, and not because of tracing highly sequential code, the starting value for the CEB fields should be left at 0 (or some small value). The distinction as to whether the trace has fewer basic blocks because of long stretches of sequential code or because of hitting a trace-formation end condition pretty quickly can be made just before pushing the trace line into the cache, by looking at the length field. This distinction may be used to set the CEB fields' starting value.

The notion of a longer trace being more important than a shorter one is thus automatically built into the CEF value by choosing appropriate initial values for the CEB field.

There are several variations along the above lines, including other functions to calculate the CEF value, other schemes to set the initial CEB field value etc, as long as the basic notion of capturing the control flow accuracy and efficiency of cache space usage are built into the measure.

The CEF value can be used to invalidate the line irrespective of or in combination with recency information. If the CEF is smaller than a certain threshold indicating that the control effectiveness is not very good, the trace line might be simply marked as invalid, thereby avoiding having to carry a useless trace line until it is eventually replaced by the replacement policy. The replacement policy might never replace it if the congruency class never fills up, and this active invalidation mechanism provides a way to invalidate the trace line in the hope that a new and better trace line will be formed using the trace formation logic.

The last step is to combine the recency-of-use information for a cache line with the CEF and compare across the multiple cache lines that make up a cache set with a certain associativity greater than 1. This can be implemented in several ways. One embodiment is to calculate a weighted multiple of the CEF for the several candidates of choice, with the weights in proportion to the recency of a line and normalized, and then to choose the one with the smallest resultant value for replacement. This multiple which may be termed the “Cache line Usefulness Factor” (here onwards alternatively referred to as CUF) provides a combined effect of recency, control flow relevance and trace length. As an example of this method, assuming three least recently used lines are chosen for selection of the replacement candidates, and the weights associated with the 3 least recently used positions are wless=0.45, wlesser=0.35 and wleast 0.20 going from more recent to least recent, the three CUF values are calculated as shown and the cache line with the smallest final value will be chosen for replacement.

CUFless=CEFless*wless

CUFlesser=CEFlesser*wlesser

CUFleast=CEFleast*wleast

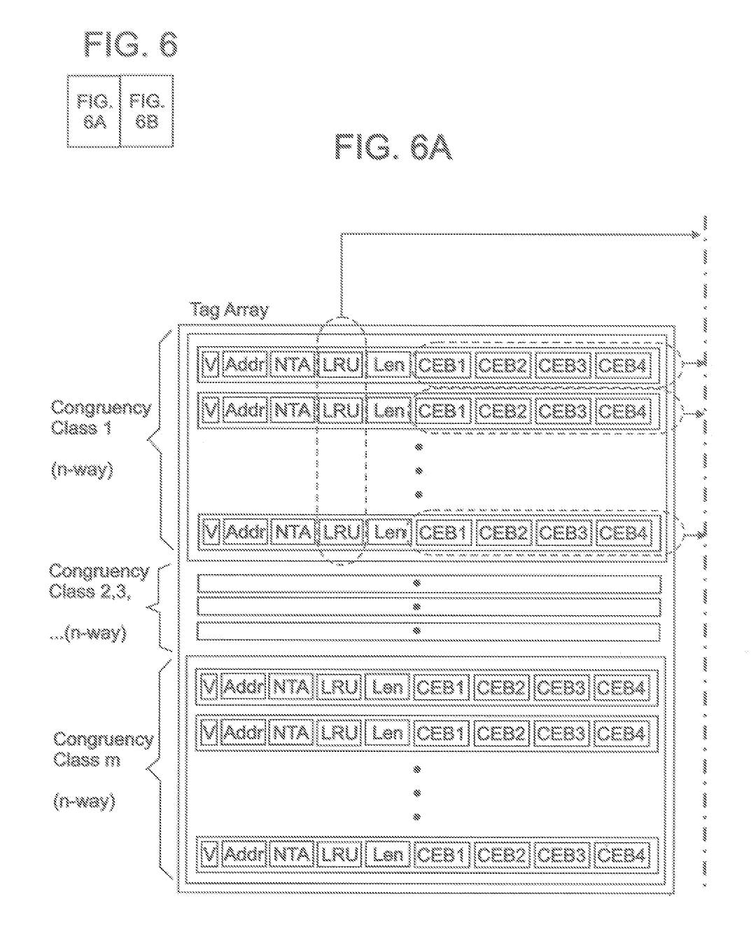

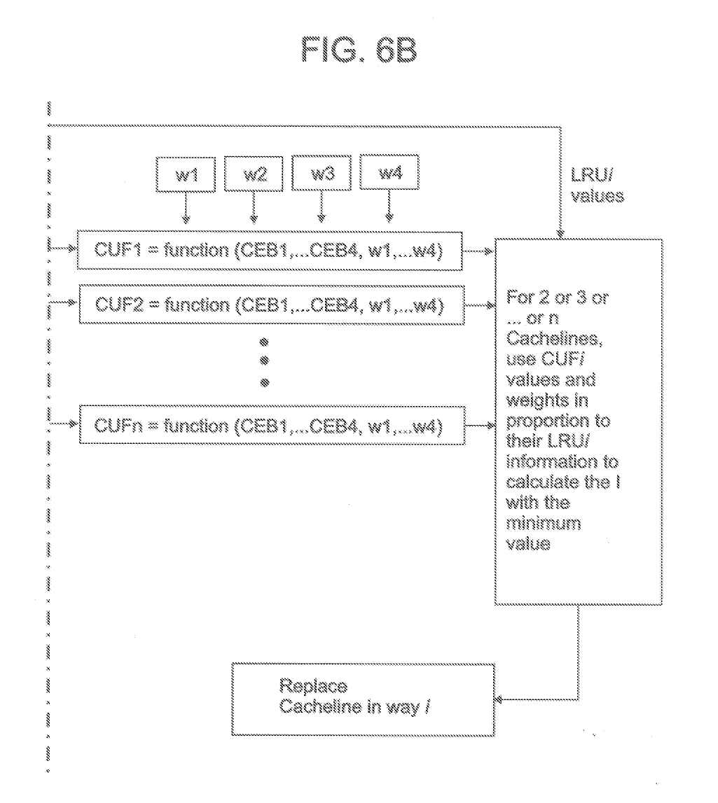

For efficient operation of the cache, the function to calculate the CEF field for a trace line, the weights associated with each of the branches in calculation of the CEF, the starting values of the CEF field and the weights associated with recency of a cache line in calculation of the CUF must be fine tuned in accordance with the benchmark characteristics. FIG. 6 shows an example scheme to evaluate the replacement trace line.

In the drawings and specifications there has been set forth a preferred embodiment of the invention and, although specific terms are used, the description thus given uses terminology in a generic and descriptive sense only and not for purposes of limitation.

What is claimed is:

1. Apparatus comprising:
a computer system central processor;
layered memory operatively coupled to said central processor and accessible thereby, said layered memory having an instruction cache with tag and data arrays; and
control logic operatively associated with said instruction cache and directing the storing in at least some locations in said data array of instruction cache lines; said control logic directing storage in said tag array of information indicative of control effectiveness and utilizing control effectiveness information in determining the storage of cache lines lines.

2. Apparatus according to claim 1 wherein said control logic directs the storage in said tag array of a plurality of Control Effectiveness Bits, each representing the effectiveness of control flow prediction in a trace line.

3. Apparatus according to claim 2 wherein said control logic delays the storage in said tag array of a plurality of Control Effectiveness Buts for an interval allowing a possible early exit from a trace line and avoids storage of a plurality of Control Effectiveness Bits in the event of such an early exit.

4. Apparatus according to claim 2 wherein said control logic responds to feedback information from the execution of a fetched line in directing storage of Control Effectiveness Bits.

5. Apparatus according to claim 4 wherein said control logic delays the storage of Control Effectiveness Bits until such time as the fetched line has executed.

6. Apparatus according to claim 2 wherein said control logic directs the storage in said tag array of information representing recency of use of a cached line (LRU information) and further wherein said control logic uses both control effectiveness information and recency of use information in determining the storage of trace lines.

7. Apparatus according to claim 2 wherein said control logic determines from the Control Effectiveness Bits stored in said tag array for a trace line a Control Effectiveness Factor representative of the effectiveness of branching prediction in the stored trace line.

8. Method comprising:
coupling together a computer system central processor and layered memory accessible by the central processor, the layered memory including an instruction cache with tag and data arrays;
under the direction of control logic operatively associated with the instruction cache selectively storing in at least some locations of the data arrays of the instruction cache both instruction trace lines;
under the direction of the control logic selectively storing in the tag arrays information indicative of the control effectiveness of trace lines; and
utilizing control effectiveness information in determining the storage of cache lines.

9. Method according to claim 8 wherein the selective storage of control effectiveness information comprises directing the storage in the tag array of a plurality of Control Effectiveness Bits, each representing the effectiveness of control flow prediction in a trace line.

10. Method according to claim 9 wherein the selective storage of control effectiveness information is delayed for an interval allowing a possible early exit from a trace line and storage of a plurality of Control Effectiveness Bits is avoided in the event of such an early exit.

11. Method according to claim 9 wherein the selective storage of control effectiveness information responds to feedback information from the execution of a fetched line in directing storage of Control Effectiveness Bits.

12. Method according to claim 11 wherein the selective storage of control effectiveness information is delayed until such time as the fetched line has executed.

13. Method according to claim 9 further comprising under the direction of the control logic information representing recency of use of a cached line (LRU information) is stored and further wherein the determining of the storage of trace lines uses both control effectiveness information and recency of use information.

14. Method according to claim 9 further comprising determining from the Control Effectiveness Bits stored in said tag array for a trace line a Control Effectiveness Factor representative of the effectiveness of branching prediction in the stored trace line.

15. Programmed method comprising:
comprising:
coupling together a computer system central processor and layered memory accessible by the central processor, the layered memory including an instruction cache with tag and data arrays;
under the direction of control logic operatively associated with the instruction cache selectively storing in at least some locations of the data arrays of the instruction cache instruction trace lines;
under the direction of the control logic selectively storing in the tag arrays information indicative of the control effectiveness of trace lines; and
utilizing control effectiveness information in determining the storage of cache lines.

16. Programmed method according to claim 15 wherein the selective storage of control effectiveness information comprises directing the storage in the tag array of a plurality of Control Effectiveness Bits, each representing the effectiveness of control flow prediction in a trace line.

17. Programmed method according to claim 16 wherein the selective storage of control effectiveness information is delayed for an interval allowing a possible early exit from a trace line and avoidance of storage of a plurality of Control Effectiveness Bits in the event of such an early exit.

18. Programmed method according to claim 16 wherein the selective storage of control effectiveness information responds to feedback information from the execution of a fetched line in directing storage of Control Effectiveness Bits.

19. Programmed method according to claim 18 wherein the selective storage of control effectiveness information is delayed until such time as the fetched line has executed.

20. Programmed method according to claim 16 further comprising under the direction of the control logic information representing recency of use of a cached line (LRU information) is stored and further wherein the determining of the storage of trace lines uses both control effectiveness information and recency of use information.

21. Programmed method according to claim 16 further comprising determining from the Control Effectiveness Bits stored in said tag array for a trace line a Control Effectiveness Factor representative of the effectiveness of branching prediction in the stored trace line.
